(19) United States
(12) Patent Application Publication
(10) Pub. No.: US 2008/0008060 A1
(43) Pub. Date: Jan. 10, 2008

(54) Light-receiving element, optical head using same, and optical recording/reproduction apparatus using same

(75) Inventors: Jun Ono, Tokyo (JP); Tomohiko Ishida, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 11/819,664

(22) Filed: Jun. 28, 2007

(30) Foreign Application Priority Data
Jul. 7, 2006 (JP) 2006-187537

(51) Int. Cl. G11B 7/00

(52) U.S. Cl. 369/44.23

(57) ABSTRACT

The invention relates to a light-receiving element for receiving light reflected at an optical recording medium, an optical head using the element, and an optical recording/reproduction apparatus using the element. The invention provides a light-receiving element capable of preventing deterioration of an electrical signal obtained through photoelectric conversion of received light, an optical head using the element, and an optical recording/reproduction apparatus using the element. The light-receiving element includes a light-receiving portion formed on a silicon substrate and a cover layer formed with a thickness that is greater in a non-light-entrance region around the light-receiving portion than in a light entrance region above the light-receiving portion when viewed in a normal direction of a substrate surface of the silicon substrate. Two outer surfaces on a light entering side of the non-light-entrance region are inclined such that their height decreases toward the light entrance region.

### BACKGROUND OF THE INVENTION

1. Field of the Invention

The present invention relates to a light-receiving element for receiving light reflected at an optical recording medium, an optical head using the element, and an optical recording/reproduction apparatus using the element.

2. Description of the Related Art

A light-receiving element used in an optical head includes a silicon substrate on which a light-receiving portion is formed and a circuit board on which the silicon substrate is disposed. The light-receiving element also includes a bonding portion constituted by electrode pads formed on the silicon substrate, electrode terminals formed on the circuit board, and wirings connecting the electrode pads and the electrode terminals. Further, the light-receiving element includes a cover layer disposed across the silicon substrate and the circuit board so as to cover the top of the light-receiving portion and the bonding portion. The cover layer serves as a protective member for preventing corrosion attributable to moisture and shorting failures attributable to dust in the air at the bonding portion.

The cover layer is made of a transparent resin to allow the light-receiving portion to receive light reflected at an optical recording medium. The light-receiving element performs photoelectric conversion of the light received at the light-receiving portion to output electrical signals from the bonding portion. A reproduction signal including information recorded on the optical recording medium and an error detection signal used for adjusting a focus error or a tracking error of the optical head are generated based on the electrical signals.

When the optical head is kept in an operating environment for a long time, dust existing in the air can be deposited on the cover layer of the light-receiving element.

Patent Document 1: JP-A-2005-5363

Patent Document 2: JP-A-2006-41456

When dust in the air is deposited on the cover layer of the light-receiving element, the dust blocks the light reflected at the optical recording medium to hinder the light from reaching the light-receiving portion. As a result, the quantity of light received at the light-receiving element is reduced. Since the electrical signals obtained through photoelectric conversion of the received light are therefore deteriorated, a reproduction signal and an error detection signal of high quality cannot be obtained.

It is an object of the invention to provide a light-receiving element which can prevent the deterioration of electrical signals obtained through photoelectric conversion of received light, an optical head using the element, and an optical recording/reproduction apparatus using the element.

### SUMMARY OF THE INVENTION

The above-described object is achieved by a light-receiving element having a substrate surface of which is vertically disposed in practical use, characterized in that it includes a light-receiving portion formed on the substrate, and a cover layer which is disposed to cover the top of the substrate and which is formed with a thickness that is greater in a non-light-entrance region around the light-receiving portion than in a light entrance region above the light-receiving portion when viewed in a normal direction of the substrate surface.

The invention provides a light-receiving element, characterized in that an outer surface of the non-light-entrance region is inclined such that a height of the outer surface becomes smaller toward the light entrance region.

The invention provides a light-receiving element, characterized in that the outer surface is inclined so as to constitute a curved surface in a neighborhood of the light entrance region.

The invention provides a light-receiving element, characterized in that the outer surface is inclined in two stages such that the height of the outer surface becomes smaller toward the light entrance region.

The invention provides a light-receiving element, characterized in that the non-light-entrance region has a substantially constant thickness.

The invention provides a light-receiving element, characterized in that the outer surface is formed substantially perpendicularly to the substrate surface in a neighborhood of the light entrance region.

The invention provides a light-receiving element, characterized in that it further includes a circuit board on which the substrate is mounted and in that the cover layer is formed across the substrate and the circuit board.

The invention provides a light-receiving element, characterized in that the cover layer has an opening formed in the light entrance region to expose the light-receiving portion.

The invention provides a light-receiving element, characterized in that the cover layer is made of a transparent material.

The invention provides a light-receiving element, characterized in that the cover layer is made of an opaque material.

The invention provides a light-receiving element, characterized in that the cover layer is made of a resin material.

The invention provides a light-receiving element, characterized in that the resin material is epoxy resin or silicone resin.

The invention provides a light-receiving element, characterized in that the substrate is a silicon substrate.

The above-described object is achieved by an optical head including an objective lens for converging light emitted by a light source on an optical recording medium and a light-receiving element having a substrate surface of which is disposed substantially vertically in practical use, the light-receiving element receiving light reflected at an optical recording medium, characterized in that the light-receiving element is a light-receiving element according to any of the above invention.

The above-described object is achieved by an optical recording/reproduction apparatus characterized in that it includes an optical head according to the above invention.

The invention makes it possible to prevent the deposition of dust on a light-receiving portion of a light-receiving element and to prevent deterioration of electrical signals obtained through photoelectric conversion of received light.

### BRIEF DESCRIPTION OF THE DRAWINGS

FIGS. 1A to 1C show a schematic configuration of a light-receiving element 1 according to an embodiment of the invention;

FIGS. 2A and 2B show an effect of the light-receiving element 1 of the embodiment, FIG. 2A showing a sectional view of the light-receiving element 1 of the embodiment, FIG. 2B showing a sectional view of a light-receiving element 31 according to the related art as a comparative example;

FIG. 3 is a sectional view of a light-receiving element 1 according to a first modification of the embodiment of the invention;

FIG. 4 is a sectional view of a light-receiving element 1 according to a second modification of the embodiment of the invention;

FIG. 5 is a sectional view of a light-receiving element 1 according to a third modification of the embodiment of the invention;

FIG. 6 is a sectional view of a light-receiving element 1 according to a fourth modification of the embodiment of the invention;

FIG. 7 is a sectional view of a light-receiving element 1 according to a fifth modification of the embodiment of the invention;

FIG. 8 is a sectional view of a light-receiving element 1 according to a sixth modification of the embodiment of the invention;

FIG. 9 is a table showing results of measurement of entering distance of test particles on light-receiving elements according to the embodiment of the invention;

FIG. 10 is a table showing results of visual evaluation on states of deposition of test particles on light-receiving elements according to the embodiment of the invention;

FIG. 11 shows a schematic configuration of an optical head 51 according to the embodiment of the invention; and

FIG. 12 shows a schematic configuration of an optical recording/reproduction apparatus 150 according to the embodiment of the invention.

### DESCRIPTION OF THE PREFERRED EMBODIMENT

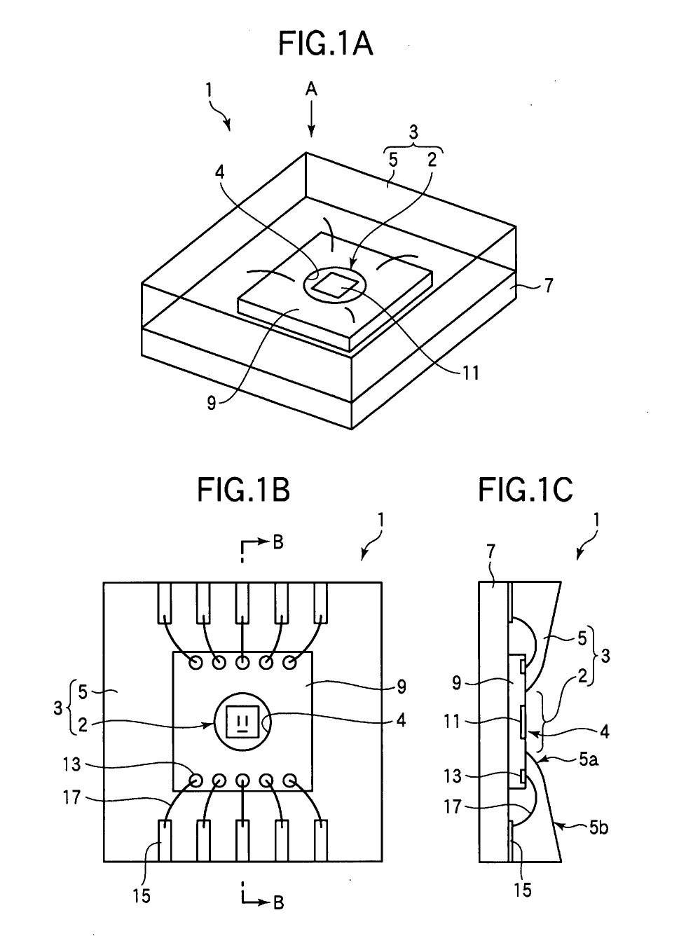

A description will now be made with reference to FIGS. 1A to 12 on a light-receiving element, an optical head using the element, and an optical recording/reproduction apparatus using the element according to an embodiment of the invention. First, a schematic configuration of a light-receiving element of the present embodiment will be described with reference to FIGS. 1A to 1C. FIG. 1A is an external perspective view of a light-receiving element 1 of the present embodiment. FIG. 1B is a plan view of the light-receiving element 1 taken in the direction of the arrow A shown in FIG. 1A. FIG. 1C is a sectional view taken along the imaginary line B-B shown in FIG. 1B. For easier understanding, FIG. 1A shows a silicon substrate 9 which is covered by a cover layer 3 and is therefore invisible in practice, and FIG. 1B shows the silicon substrate 9 that is invisibly covered by the cover layer 3 in practice and other internal structures.

As shown in FIGS. 1A to 1C, the light-receiving element 1 includes a circuit board 7 in the form of a thin plate and the cover layer 3 which has a light entrance region 2 in the form of a recess located above a light-receiving portion 11, and the element as a whole is in the form of a rectangular parallelepiped. A silicon substrate 9 in the form of a thin plate is mounted substantially in the middle of the circuit board 7. The light-receiving element 1 includes the light-receiving portion 11 which is formed substantially in the middle of a substrate surface of the silicon substrate 9. The cover layer 3 is formed across the silicon substrate 9 and the circuit board 7. The cover layer 3 is formed with a thickness that is greater in a non-light-entrance region 5 around the light-receiving portion 11 than in the light entrance region 2 above the light-receiving portion 11 when viewed in the normal direction of the substrate surface of the silicon substrate 9.

The cover layer 3 has an opening 4 which is formed in the light entrance region 2 to expose the light-receiving portion 11. As shown in FIG. 1C, outer surfaces 5a and 5b on a light entering side of the non-light-entrance region 5 are inclined such that the height of the surfaces becomes smaller toward the light entrance region 2. Referring to the sectional view, the non-light-entrance region 5 has an outer surface 5b which is inclined in the form of a straight line such that the height of the surface becomes smaller toward the light entrance region 2 from the height at ends of the circuit board 7 and an outer surface 5a which is inclined in the form of a curve in the neighborhood of the light entrance region 2. The outer surface 5a is inclined in the form of a curved surface protruding on the light entering side of the element. Thus, the cover layer 3 has such a shape that the thickness of the layer is greatest at the ends of the circuit board 7 and smallest at the light entrance region 2.

Referring to FIG. 1C, the tangent (not shown) to the outer surface 5a at the point where the outer surface 5a meets the silicon substrate 9 is at an angle of inclination of, for example, about 45° to the substrate surface of the silicon substrate 9, and the outer surface 5b is at an angle of inclination of, for example, about 10° to the substrate surface of the silicon substrate 9. Referring to FIG. 1C, the radius of the opening 4, the length of the outer surface 5a, and the length of the outer surface 5b are at a ratio of, for example, 1:1.4:3.6 in the in-plane direction of the silicon substrate 9.

The cover layer 3 is made of an opaque insulating material such as an epoxy resin material or a silicon resin material. Although the cover layer 3 is made of an opaque material because the cover layer 3 has the opening 4, a transparent material may obviously be used. For example, the cover layer 3 may be made of a transparent insulating material such as a transparent epoxy resin material or glass material. In general, the cost of a transparent resin material is about 1.5 to 2 times higher than the cost of an opaque resin material. Therefore, the cost of the cover layer 3 can be kept low by forming the opening 4 in the light entrance region 2 to allow the cover layer 3 to be made of an opaque epoxy resin material. Thus, the light-receiving element 1 can be provided at a low cost.

As shown in FIG. 1B, the silicon substrate 9 includes a plurality of electrode pads 13 formed along each of a pair of opposite edges of the silicon substrate 9. For example, electrode terminals 15 in the same quantity as the electrode pads 13 are formed on a pair of opposite edges of the circuit board 7 extending along the above-mentioned edges of the silicon substrate 9. The light-receiving element 1 is electrically connected to a mounting board (not shown) on which the light-receiving element 1 is to be mounted using the electrode terminals 15. The plurality of electrode pads 13 are electrically connected to the plurality of electrode terminals 15 respectively through a plurality of wirings 17. The light-receiving element 1 performs photoelectric conversion of light that it has received at the light-receiving portion 11 and output electrical signals from the electrode pads 13. The electrical signals are input to predetermined circuits on the circuit board on which the light-receiving element 1 is mounted through the wirings 17 and the electrode terminals 15. The silicon substrate 9 and the circuit board 7 constitute a COB (Chip on Board) circuit board.

The cover layer 3 is formed to cover a bonding portion which is constituted by the electrode pads 13, the wirings 17, and the electrode terminals 15. The cover layer 3 also serves as a protective member for preventing corrosion of the bonding portion attributable to moisture and shorting failures at the bonding portion attributable to dust.

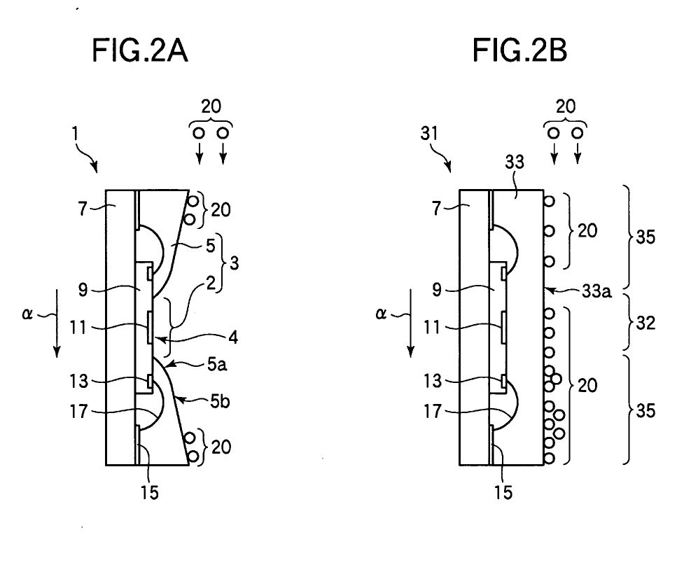

The effects of the light-receiving element 1 will now be described with reference to FIGS. 2A and 2B. FIG. 2A shows a section of the light-receiving element 1 of the present embodiment, and FIG. 2B shows a section of a light-receiving element 31 according to the related art as a comparative example. As shown in FIGS. 2A and 2B, the light-receiving elements 1 and 31 are disposed such that a substrate surface of a silicon substrate 9 extends substantially in parallel with a vertical direction α. Dust 20 existing in the air falls in a substantially vertical downward direction due to the gravity.

As shown in FIG. 2B, the light-receiving element 31 according to the related art includes a cover layer 33 which has a substantially constant thickness in a light entrance region 32 above a light-receiving portion 11 and in a non-light-entrance region 35 around the light-receiving portion 11 when viewed in the normal direction of the substrate surface of the silicon substrate 9. The cover layer 33 has a flat outer surface 33a which is substantially in parallel with the vertical direction α. Dust 20 falling in the neighborhood of the cover layer 33 can contact or collide with the outer surface 33a. Then, the dust 20 and the outer surface 33a are charged due to friction between the dust 20 and the outer surface 33a, and static electricity is generated. The cover layer 33 is grounded through a circuit board which is not shown. However, since the cover layer 33 is made of an insulating material, substantially no static electricity generated at the dust 20 and the outer surface 33a leaks to the circuit board. Therefore, the dust 20 and the outer surface 33a stay in the charged state. Since the length of the outer surface 33a is relatively great in the vertical direction a, particles of dust 20 which have reached a lower part of the outer surface 33a have a great amount of charge. Thus, the particles of dust 20 are deposited on the lower part of the outer surface 33a when viewed in the vertical direction. Particles of dust 20 in the air are gradually deposited on the outer surface 33a around the particles of dust 20 on the surface 33a serving as kernels. As a result, dust 20 is deposited also on the outer surface 33a above the light-receiving portion 11. The dust 20 deposited on the light-receiving portion 11 hinders the light-receiving portion 11 from receiving light entering substantially in the horizontal direction. Therefore, when the light-receiving element 31 according to the related art is kept in an operating environment for a long time, the amount of light received by the element is reduced by the dust.

On the contrary, as shown in FIG. 2A, the outer surfaces 5a and 5b of the non-light-entrance region 5 of the light-receiving element 1 in the present embodiment are inclined such that the height of the surfaces decreases toward the light entrance region 2. Therefore, the length of a part of the outer surfaces 5a and 5b which can be regarded substantially parallel to the vertical direction a is very much smaller than the length of a comparative part of the light-receiving element 31 according to the related art. Thus, even if particles of dust 20 falling in the neighborhood of the cover layer 3 contact or collide with the outer surface 5b, most of the particle of dust 20 move on the outer surface 5b a predetermined distance without being charged. Thereafter, the particles move away from the outer surface 5b and fall vertically downward. As thus described, the light-receiving element 1 can prevent the deposition of dust 20 on the outer surfaces 5a and 5b of the non-light-entrance region 5. Any reduction in the quantity of light received by the light-receiving element 1 can be prevented because the deposition of dust 20 on the light-receiving portion 11 can be prevented as thus described.

As described above, even if the light-receiving element 1 of the present embodiment is kept in an operating environment for a long time, dust in the air can be prevented from being deposited on the light-receiving portion 11 by the cover layer 3. Since any reduction in the quantity of light received by the light-receiving element 1 can therefore be prevented, the quality of electrical signals obtained through photoelectric conversion of the quantity of received light can be satisfactorily maintained. It is therefore possible for the light-receiving element 1, to prevent the deterioration of a reproduction signal and an error detection signal for adjusting a focus error or a tracking error of an optical head generated based on the electrical signals.

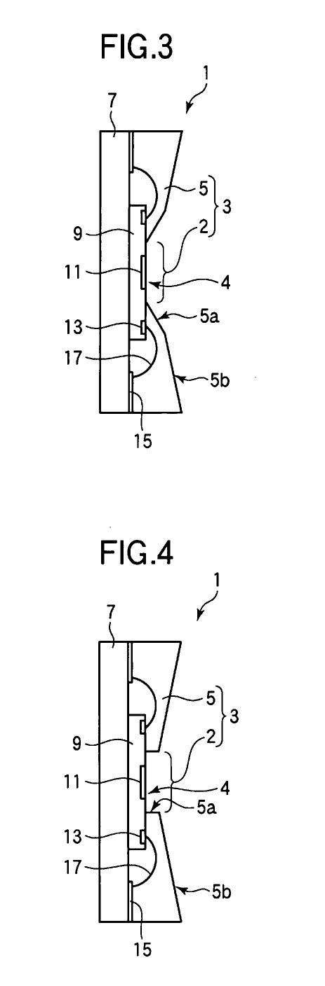

Schematic configurations of light-receiving elements according to first to sixth modifications of the present embodiment will now be described with reference to FIGS. 3 to 8. The light-receiving elements according to the first to sixth modifications are similar to the light-receiving element 1 shown in FIG. 2A in that a substrate surface of a silicon substrate 9 is disposed substantially in parallel with the vertical direction in practical use. First, a schematic configuration of the light-receiving element according to the first modification of the embodiment will be described with reference to FIG. 3. Referring to the light-receiving element 1 shown in FIG. 2A, the non-light-entrance region 5 has the outer surface 5b which is inclined in the form of a straight line and the outer surface 5a which is inclined in the form of a curve, as shown in the sectional view. The light-receiving element of the present modification is characterized in that it has an outer surface which is inclined in two stages in form of straight lines such that the height of the surface decreases toward the light entrance region in the sectional view. In the description of the present and following modifications, components having the same effects and functions as those of the components of the light-receiving elements 1 shown in FIG. 2A will not be described, and will be indicated by same reference numerals.

FIG. 3 is a sectional view of the light-receiving element 1 of the present modification. As shown in FIG. 3, the light-receiving element 1 of the present modification is similar to the light-receiving element 1 shown in FIG. 2A in that it includes a cover layer 3 having an opening 4 which is formed in a light entrance region 2 to expose a light-receiving portion 11. Referring to the sectional view, a non-light-entrance region 5 of the cover layer 3 has an outer surface 5b which is inclined in the form of a straight line such that the height of the surface decreases toward the light entrance region 2 from the height at ends of a circuit board 7 and an outer surface 5a which is inclined in the form of a straight line such that the height of the surface decreases toward the light entrance region 2 from the height at the end of the surface adjoining the surface 5b. The outer surface 5a is formed as a curved surface like a mortar. The cover layer 3 has such a shape that it is a greatest in thickness at the ends of the circuit board 7 and smallest in thickness at the light entrance region 2.

The outer surfaces 5a and 5b are inclined at different angles to a substrate surface of a silicon substrate 9. Therefore, the non-light-entrance region 5 is inclined in two stages. Referring to FIG. 3, for example, the outer surface 5a is inclined at an angle of about 45° to the substrate surface of the silicon substrate 9, and the outer surface 5b is inclined at an angle of about 10° to the substrate surface of the silicon substrate 9. In FIG. 3, for example, the radius of the opening 4, the length of the outer surface 5a, and the length of the outer surface 5b are at a ratio of 1:1.4:3.6 in the in-plane direction of the silicon substrate 9.

The light-receiving element 1 of the present modification includes the non-light-entrance region 5 having the outer surfaces 5a and 5b inclined in the form of two straight lines forming a step when the element is viewed in a sectional view. As a result, the light-receiving element 1 of the present modification provides the same effect as that of the light-receiving element 1 shown in FIG. 2A.

A schematic configuration of a light-receiving element according to a second modification of the embodiment will now be described with reference to FIG. 4. The light-receiving element 1 of the first modification includes the cover layer 3 having the inclined outer surface 5a in the neighborhood of the light entrance region 2. On the contrary, the light-receiving element of the present modification is characterized in that a cover layer of the element has an outer surface which is formed substantially perpendicularly to a substrate surface of a silicon substrate in the neighborhood of a light entrance region.

FIG. 4 is a sectional view of a light-receiving element 1 of the present modification. As shown in FIG. 4, the light-receiving element 1 of the present modification is similar to the light-receiving element 1 shown in FIG. 2A in that it includes a cover layer 3 having an opening 4 which is formed in a light entrance region 2 to expose a light-receiving portion 11. Referring to the sectional view, a non-light-entrance region 5 of the cover layer 3 has an outer surface 5b which is inclined in the form of a straight line such that the height of the surface becomes smaller toward the light entrance region 2 than at ends of a circuit board 7 and an outer surface 5a which is formed substantially perpendicularly to a substrate surface of a silicon substrate 9 in the neighborhood of the light entrance region 2. For example, the outer surface 5a is formed as a curved surface like a cylinder. Referring to FIG. 4, the outer surface 5b is inclined at an angle of, for example, about 10° to the substrate surface of the silicon substrate 9. The cover layer 3 has such a shape that it is greatest in thickness at the ends of the circuit board 7 and smallest in thickness at the light entrance region 2.

The light-receiving element 1 of the present modification includes the non-light-entrance region 5 having the outer surface 5b which is inclined such that the height of the same decreases toward the light entrance region 2. Thus, the light-receiving element 1 of the present modification provides the same effect as that of the light-receiving elements 1 shown in FIGS. 2A and 3.

A schematic configuration of a light-receiving element according to a third modification of the embodiment will now be described with reference to FIG. 5. The light-receiving element 1 of the first modification includes the cover layer 3 having the outer surfaces 5a and 5b which are inclined in two stages with different angles to the substrate surface of the silicon substrate 9. The light-receiving element of the present modification is characterized in that it includes a cover layer which is inclined in the form of a straight line when viewed in a section of the element such that an outer surface of the layer becomes lower toward a light entrance region.

FIG. 5 is a sectional view of the light-receiving element 1 of the present modification. As shown in FIG. 5, the light-receiving element 1 of the present modification is similar to the light-receiving element 1 shown in FIG. 2A in that it includes a cover layer 3 having an opening 4 which is formed in a light entrance region 2 to expose a light-receiving portion 11. Referring to the sectional view, a non-light-entrance region 5 of the cover layer 3 has an outer surface 5a which is inclined in the form of a straight line such that the height of the surface decreases toward the light entrance region 2 from the height at ends of a circuit board 7. The outer surface 5a is formed as a curved surface like a mortar. Referring to FIG. 5, the outer surface 5a is inclined at an angle of, for example, about 10° to a substrate surface of a silicon substrate 9. The cover layer 3 has such a shape that the layer has a greatest thickness at ends of a circuit board 7 and a smallest thickness at the light entrance region 2.

The light-receiving element 1 of the present modification includes the non-light-entrance region 5 having the outer surface 5a inclined such that the height of the surface decreases toward the light entrance region 2. As a result, the light-receiving element 1 of the present modification provides the same effect as that of the light-receiving elements 1 shown in FIGS. 2A, 3, and 4.

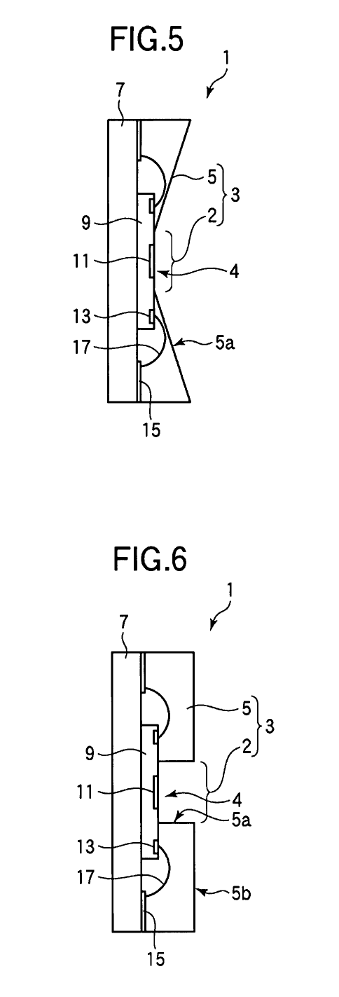

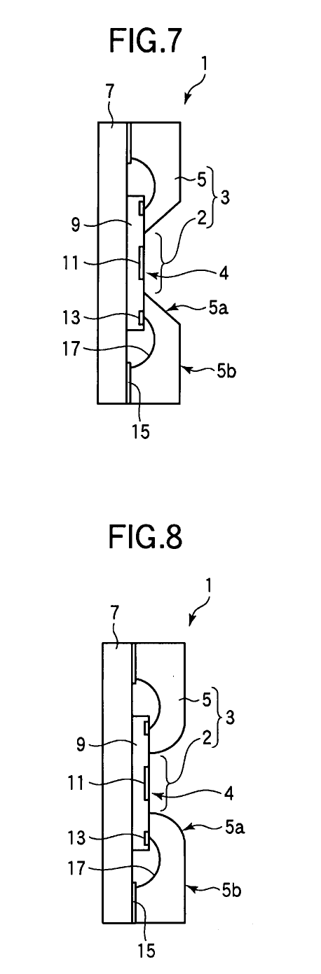

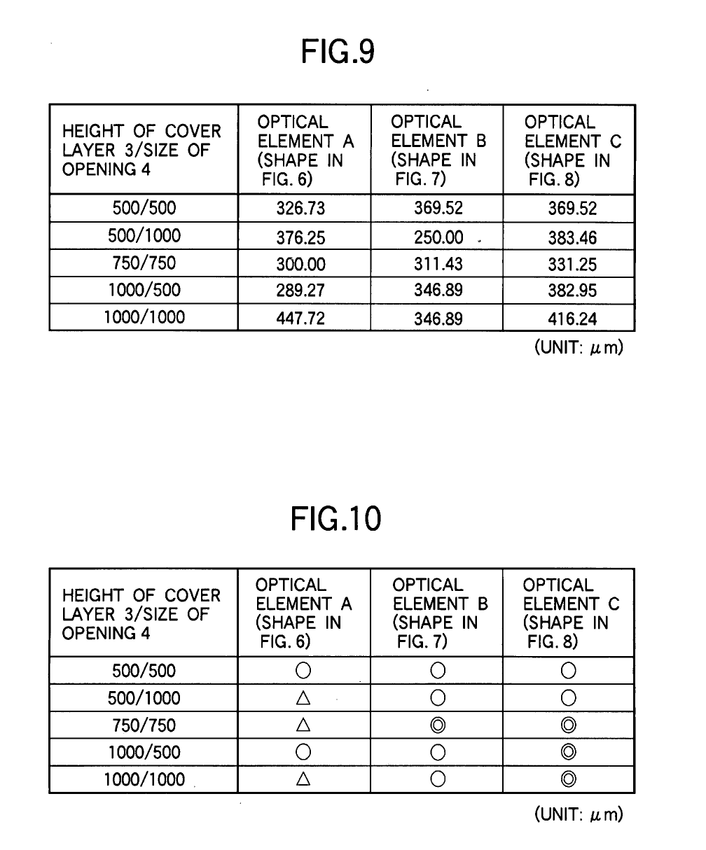

A schematic configuration of a light-receiving element according to a fourth modification of the embodiment will now be described with reference to FIG. 6. The light-receiving elements 1 shown in FIGS. 2A, 3, 4, and 5 include the cover layer 3 having the outer surfaces inclined such that the height of the surfaces decreases toward the light entrance region 2. The light-receiving element of the present modification is characterized in that it includes a cover layer whose outer surface is substantially in parallel with a substrate surface of a silicon substrate.

FIG. 6 is a sectional view of a light-receiving element 1 of the present modification. As shown in FIG. 6, the light-receiving element 1 of the present modification is similar to the light-receiving element 1 shown in FIG. 2A in that it includes a cover layer 3 having an opening 4 which is formed in a light entrance region 2 to expose a light-receiving portion 11. A non-light-entrance region 5 of the cover layer 3 is formed with a substantially constant thickness above a substrate surface of a silicon substrate 9. The non-light-entrance region 5 has an outer surface 5b on a light entering side thereof, formed substantially in parallel with the substrate surface of the silicon substrate 9. The region also has an outer surface 5a which is formed substantially perpendicularly to the substrate surface of the silicon substrate 9 in the neighborhood of the light entrance region 2 as shown in the sectional view. The outer surface 5a is formed as a curved surface like a cylinder.

The light-receiving element 1 of the present modification does not have an outer surface inclined such that the height of the surface decreases toward the light entrance region 2. In this light-receiving element 1, however, the deposition of dust on a light-receiving portion 11 can be prevented because the length of the outer surface 5b in the vertical direction is shorter than that of the outer surface of the light-receiving element 31 according to the related art shown in FIG. 2B. Thus, the light-receiving element 1 of the present modification can provide the same effect as that of the light-receiving elements 1 shown in FIGS. 2A, 3, 4, and 5.

A schematic configuration of a light-receiving element according to a fifth modification of the embodiment will now be described with reference to FIG. 7. The light-receiving element 1 of the fourth modification includes the cover layer 3 having the outer surface 5a which is formed substantially perpendicularly to the substrate surface of the silicon substrate 9 in the neighborhood of the light entrance region 2. A light-receiving element of the present modification is characterized in that it has an outer surface which is inclined in the form of a straight line in the neighborhood of a light entrance region when the light-receiving element is viewed in a section thereof.

FIG. 7 is a sectional view of a light-receiving element 1 according to the present modification. As shown in FIG. 7, the light-receiving element 1 of the present modification is similar to the light-receiving element 1 shown in FIG. 6 in that it includes a cover layer 3 having an opening 4 which is formed in a light entrance region 2 to expose a light-receiving portion 11. A non-light-entrance region 5 has an outer surface 5b which is formed substantially in parallel to a substrate surface of a silicon substrate 9 on a light entering side thereof and an outer surface 5a which is formed as a straight incline in the neighborhood of a light entrance region 2 as shown in the sectional view of the light-receiving element 1. For example, the outer surface 5a is formed as a curved surface like a mortar.

Referring to FIG. 7, the outer surface 5a is inclined at an angle of, for example, about 45° to the substrate surface of the silicon substrate 9. Referring to FIG. 7, the radius of the opening 4, the length of the outer surface 5a, and the length of the outer surface 5b are at a ratio of 1:1.4:3.6 in the in-plane direction of the silicon substrate 9.

The light-receiving element 1 of the present modification includes the non-light-entrance region 5 having the outer surface 5a which is inclined such that the height of the surface becomes lower toward the light entrance region 2. Further, the deposition of dust on the light-receiving portion 11 can be prevented because the length of the outer surface 5b of the light-receiving element 1 in the vertical direction is shorter than that of the outer surface of the light-receiving element 31 according to the related art shown in FIG. 2B. Thus, the light-receiving element 1 of the present modification can provide the same effect as that of the light-receiving elements 1 shown in FIGS. 2A, 3, 4, 5, and 6.

A schematic configuration of a light-receiving element according to a sixth modification of the embodiment will now be described with reference to FIG. 8. The light-receiving element 1 of this modification includes the cover layer 3 having the outer surface 5a which is inclined in the form of a straight line in the neighborhood of the light entrance region 2 in a sectional view of the light-receiving element 1. On the contrary, a light-receiving element of the present modification is characterized in that it has an outer surface inclined in the form of a curve in the neighborhood of a light entrance region when the light-receiving element is viewed in a section thereof.

FIG. 8 is a sectional view of a light-receiving element 1 according to the present modification. As shown in FIG. 8, the light-receiving element 1 of the present modification is similar to the light-receiving element 1 shown in FIG. 7 in that it includes a cover layer 3 having an opening 4 which is formed in a light entrance region 2 to expose a light-receiving portion 11. A non-light-entrance region 5 has an outer surface 5b which is formed substantially in parallel with a substrate surface of a silicon substrate 9 on a light entering side thereof and an outer surface 5a which is formed as an incline in the form of a curve in the neighborhood of the light entrance region 2 as shown in FIG. 8. For example, the outer surface 5a is formed like an arc of a circle having a radius substantially equal to the diameter of the opening 4. The outer surface 5a is inclined, for example, in the form of a curved surface protruding on the light entering side of the element.

In FIG. 8, the tangent (not shown) to the outer surface 5a in the point where the outer surface 5a meets the silicon substrate 9 is at an angle of, for example, about 90° to the substrate surface of the silicon substrate 9. Referring also to FIG. 8, the radius of the opening 4, the length of the outer surface 5a, and the length of the outer surface 5b are at a ratio of, for example, 1:1.4:3.6 in the in-plane direction of the silicon substrate 9.

The light-receiving element 1 of the present modification includes the non-light-entrance region 5 having the outer surface 5a which is inclined such that the height of the surface decreases toward the light entrance region 2 and the outer surface 5b which is formed substantially in parallel with the substrate surface of the silicon substrate 9 on a light entering side thereof. Thus, the light-receiving element 1 of the present modification provides the same effect as that of the light-receiving elements 1 shown in FIGS. 2A, 3, 4, 5, 6, and 7.

A description will now be made with reference to FIGS. 9 and 10 on a residual dust test carried out on light-receiving elements according to the present embodiment. First, a method of a residual dust test on a light-receiving element will be described. A residual dust test on a light-receiving element is carried out as follows. The light-receiving element is disposed in a testing chamber of a dust tester. Then, a large amount of test particles are dropped in the vertical direction and deposited on the light-receiving element to reproduce a state that the light-receiving element it is kept in an actual operating environment for a predetermined time. Then, the amount of residual test particles left on the cover layer of the light-receiving element is measured.

A description will now be made on evaluation samples used for a residual dust test on light-receiving elements. Light-receiving elements having configurations shown in FIGS. 6 to 8 are used as evaluation samples. Hereinafter, an evaluation sample having the configuration shown in FIG. 6 is referred to as a light-receiving element A; an evaluation sample having the configuration shown in FIG. 7 is referred to as a light-receiving element B; and an evaluation sample having the configuration shown in FIG. 8 is referred to as a light-receiving element C. Five types of evaluation samples which are different in the height of the cover layer 3 and in the size of the opening 4 are prepared for each of the light-receiving elements A to C. The samples are formed to have respective cover layers 3 and openings 4 with respective cover layer height/opening size combinations, i.e., 500 μm/500 μm, 500 μm/1000 μm, 750 μm/750 μm, 1000 μm/500 μm, and 1000 μm/1000 μm. Referring to FIGS. 6 to 8, the height of a cover layer 3 is the thickness of the cover layer 3, i.e., the distance from the outer surface 5b to the substrate surface of the silicon substrate 9. Referring also to FIGS. 6 to 8, the size of an opening 4 is the distance between parts of the outer surface 5a facing each other above the substrate surface of the silicon substrate 9.

The outer surface 5a of a light-receiving element A is formed at an angle of substantially 90° to the substrate surface of the silicon substrate 9 in the section shown in FIG. 6 regardless of the height of the cover layer 3 and the size of the opening 4. The outer surface 5a of a light-receiving element B is at an inclination angle of substantially 45° to the substrate surface of the silicon substrate 9 in the section shown in FIG. 7 regardless of the height of the cover layer 3 and the size of the opening 4. In the section shown in FIG. 8, the curved shape of the outer surface 5a of a light-receiving element C varies depending on the height of the cover layer 3 and the size of the opening 4. The outer surface 5a of a light-receiving element C is formed like an arc of a circle having a radius of 800 μm when the height of the cover layer 3 is 500 μm and the size of the opening 4 is 500 μm. The outer surface is formed like an arc of a circle having a radius of 1300 μm when the height of the cover layer 3 is 500 μm and the size of the opening 4 is 1000 μm. The outer surface is formed like an arc of a circle having a radius of 1100 μn when the height of the cover layer 3 is 750 μm and the size of the opening 4 is 750 μm. The outer surface is formed like an arc of a circle having a radius of 800 μm when the height of the cover layer 3 is 1000 μm and the size of the opening 4 is 500 μm. The outer surface is formed like an arc of a circle having a radius of 1300 μm when the height of the cover layer 3 is 1000 μm and the size of the opening 4 is 1000 μm.

The residual dust test on the light-receiving elements will now be specifically described. The light-receiving elements A to C are placed in the testing chamber of the dust tester with the substrate surfaces of the silicon substrates 9 disposed substantially in parallel with the vertical direction. Next, the testing chamber is sealed, and a large amount of testing particles are vertically injected and dropped from above the light-receiving elements A to C. Eight types of testing particles (Kanto loam) defined in JIS specification Z8901 are used as the testing particles. The testing particles are injected and dropped in the testing chamber to deposit dust in an amount sufficient to reproduce a state that the light-receiving elements A to C enter when they are kept in an actual operating environment for 18 years based on IEC60721-3-3 Class 3S1 specification. Next, the light-receiving elements A to C are taken out from the dust tester, and the entering distance of the test particles is measured using a digital microscope. Further, the state of deposition of test particles on the light-receiving elements A to C (the amount, position, and size of residual test particles) is visually evaluated. A entering distance is the length of a set of residual test particles spreading from the outer surface 5b of an element onto the outer surface 5a toward the silicon substrate 9, measured in the normal direction of the substrate surface of the silicon substrate 9.

FIG. 9 shows results of measurement of entering distances of test particles. The leftmost columns of FIG. 9 show the heights of the cover layers 3 of the light-receiving elements A to C and the sizes of the openings 4 of the elements. The leftmost columns are followed by columns on the right of the same showing entering distances of test particles on the light-receiving elements A, B, and C in the order listed. As shown in FIG. 9, there is no significant difference between the entering distances of test particles attributable to the shapes of the outer surfaces 5a of the cover layers 3, the heights of the cover layers 3, and the sizes of the openings 4. The entering distances of test particles on all evaluation samples under measurement are within the range from 250 μm to 450 μm.

FIG. 10 shows results of visual evaluation made on states of deposition of test particles. The leftmost columns of FIG. 10 show the heights of the cover layers 3 of the light-receiving elements A to C and the sizes of the openings 4 of the elements. The leftmost columns are followed by columns on the right of the same showing results of visual evaluation of test particles on the light-receiving elements A, B, and C in the order listed. A double circle on the table indicates that substantially no test particle is deposited. A circle indicates that a small amount of test particles are deposited. A triangle indicates that the amount of test particles deposited is relatively great, but the level of deposition is not problematic in practical use.

The results shown in FIG. 10 indicate that test particles are most unlikely to remain on the light-receiving elements C, next unlikely to remain on the light-receiving elements B, and most likely to remain on the light-receiving elements A. Therefore, the light-receiving elements C including a cover layer 3 having an outer surface 5a inclined in the form of a curved surface are better than the light-receiving elements A and B in the effect of preventing the deposition of dust existing in the air from being deposited on the cover layer 3.

Test particles deposited on a light-receiving element B tend to remain at the step portion constituting the boundary between the outer surfaces 5a and 5b in a greater amount than in other regions. Therefore, in order to improve the dust deposition preventing effect of the light-receiving element B, end face treatment must be performed on the step portion. For example, when end face treatment is performed to treat the step portion into a curved surface, the light-receiving element B will have the same effect as achieved by the light-receiving elements C. It is therefore possible to improve the effect of preventing dust existing in the air from being deposited on the cover layer 3.

Test particles remain on the light-receiving elements A in a greater amount than on the light-receiving elements B and C. When the residual dust test is carried out on the light-receiving element 31 according to the related art shown in FIG. 2B under the same condition, test particles are deposited to such a degree that the light-receiving portion becomes invisible. When compared to the light-receiving element 31 according to the related art, the amount of test particles deposited on the light-receiving elements A is quite small, and the deposition of test particles on the light-receiving portion 11 can be prevented. Therefore, the light-receiving elements A including the cover layer 3 having the outer surface 5a at an angle of substantially 90° to the substrate surface of the silicon substrate 9 can achieve the effect of preventing dust existing in the air from being deposited on the cover layer 3 similarly to the light-receiving elements B and C, and will not have any problem in practical use.

A relationship between the height of the cover layer 3 and the size of the opening 4 will be described. As shown in FIG. 10, in all of the light-receiving elements A to C, test particles are most unlikely to remain when the height of the cover layer 3 is 1000 μm and the size of the opening 4 is 500 μm. The height of the cover layer 3 is associated with the size of the opening 4, and the cover layer 3 is preferably provided with a height that is one-third or more of the size of the opening 4 in order to keep the cover layer resistant to the deposition of dust.

As described above, the deposition of dust in the air on the light-receiving portion 11 of a light-receiving element can be prevented when the non-light-entrance region 5 is formed greater in thickness than the light entrance region 2 having the opening 4 regardless of the shape of the outer surface 5a of the non-light-entrance region 5.

The light-receiving element 31 according to the related art includes the cover layer 33 covering the top of the light-receiving portion 11 and having the substantially flat outer surface 33a. Therefore, when the light-receiving element 31 is handled with a bare hand, for example, during an operation of transporting or mounting the light-receiving element 31, the outer surface 33a above the light-receiving portion 11 can be touched by the hand, although the light entrance surface of the light-receiving portion 11 will not be directly touched. It is therefore difficult to handle the light-receiving element 31 according to the related art with a bare hand even through the element has the cover layer 33. On the contrary, the light-receiving element 1 of the embodiment includes the cover layer 3 formed with a thickness that is greater in the non-light-entrance region 5 around the light-receiving portion 11 than in the light entrance region 2 above the light-receiving portion 11. Thus, in the light-receiving element 1, there is a predetermined distance (a height difference) between the outer surface 5b of the non-light-entrance region 5 and the light-receiving portion 11. It is therefore possible for the light-receiving element 1 to prevent a finger tip of a person from touching the light-entering surface of the light-receiving portion 11, for example, when the element is handled with a bare hand during a transporting or mounting operation even though the element has the opening 4 where the light-receiving portion 11 is exposed. As a result, the light-receiving element 1 can be easily handled with a bare hand.

A unique effect of the provision of the opening 4 on the light-receiving element 1 will now be described. In order to increase the recording density of an optical head, the wavelength of the light source must be made shorter. For example, the wavelength of a light source used in a compact disc (CD) apparatus is around 780 nm, whereas the wavelength of a light source used in a digital versatile disc (DVD) apparatus is 650 nm. Recently, the wavelength of such light sources has been decreased to about 400 nm. In general, a reduction in the wavelength of a light source results in changes in characteristics of an optical component such as chromatic aberration, transmittance, and durability, and such changes in characteristics become significant when the wavelength is decreased below to about 400 nm. Therefore, even an optical component usable in an optical wave band used for CD apparatus and DVD apparatus may be disabled when a light source of about 400 nm is used.

Specifically, an optical component or adhesive made of resin is irradiated with light having high power and a short wavelength for a long time, the resin can undergo chemical changes, which can result in a change in the transmittance of the resin or damage on the resin such as deformation. A glass material can be used instead of resin for a component disposed in the optical path of laser light. However, a problem will arise in that the component will incur high processing and assembling costs.

The light-receiving element 1 of the embodiment has the opening 4 in the cover layer 3. Therefore, the light-receiving element 1 can be configured such that the cover layer 3 made of resin is excluded from the neighborhood of the light-receiving portion 11. As a result, since the resin is not irradiated with light having high power and a short wavelength, any change in transmittance or deformation of the light-receiving element 1 attributable to chemical changes in the resin can be prevented. Further, since the coating of the resin involves mounting techniques of a low level of difficulty, no expensive coating apparatus is required, and manufacturing facility for the light-receiving element 1 can be provided at a low cost. For example, resin coating can be performed manually instead of using an automatic coating apparatus.

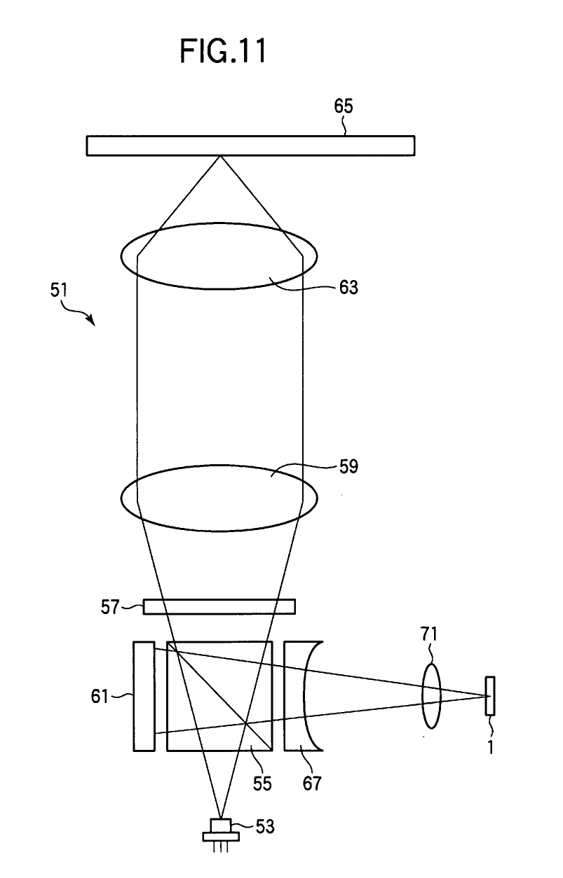

A schematic configuration of an optical head according to the present embodiment will now be described with reference to FIG. 11. For example, an optical head 51 includes a laser diode 53 as a laser emission element emitting laser light. The laser diode 53 can emit laser beams having different optical intensities for recording and reproduction based on control voltages from a controller (not shown in FIG. 11).

A polarization beam splitter 55 is disposed in a predetermined position on a light exiting side of the laser diode 53. On the light transmitting side of the polarization beam splitter 55 with respect to the laser diode 53, a quarter wave plate 57, a collimator lens 59, and an objective lens 63 are disposed in a line in the order listed. On the light reflecting side of the polarization beam splitter 55 with respect to the laser diode 53, a power monitoring photodiode 61 for measuring the optical intensity of a laser beam emitted by the laser diode 53 is disposed. The collimator lens 59 is provided to transform a divergent pencil of beams from the laser diode 53 into a parallel pencil of beams and to guide the parallel beams to the objective lens 63. It also transforms a parallel pencil of beams from the objective lens 63 into a convergent pencil of beams and guides the convergent beams to the light-receiving element 1. The objective lens 63 is provided to converge the parallel pencil of beams from the collimator lens 59 on an information recording surface of an optical recording medium 65 and form a reading spot on the same. It also transforms light reflected at the optical recording medium 65 into a parallel pencil of beams and guides the beams to the collimator lens 59.

On the light reflecting side of the polarization beam splitter 55 with respect to the quarter wave plate 57, a sensor lens 67 and a cylindrical lens 71 are disposed in a line in the order listed. On the light transmitting side of the cylindrical lens 71, a light-receiving element 1 for receiving reflected light from the optical recording medium 65 is disposed. The light-receiving element 1 is disposed such that a substrate surface of a silicon substrate 9 formed with a light-receiving portion 11 (both of the components are not shown in FIG. 11) faces substantially in the vertical direction when the element is actually used.

The sensor lens 67 serves as a reflected light focus position adjusting portion for performing optical adjustment of the focus position of light reflected at the optical recording medium 65. The sensor lens 67 also causes astigmatism at reflected light from the optical recording medium 65 and enlarges the reflected light at a predetermined optical magnification to form an image on the light-receiving portion 11 of the light-receiving element 1. Electrical signals obtained through photoelectric conversion at the light-receiving element 1 are processed in a predetermined circuit provided on an optical recording/reproduction apparatus which is not shown, to extract a reproduction signal including information recorded on the optical recording medium 65 and to generate an error detection signal for adjusting a focus error or a tracking error of the optical head 51. Since substantially no dust is deposited on the light-receiving portion 11 even when the light-receiving element 1 is kept in an operating environment for a long time, any reduction in the quantity of received light can be prevented. Therefore, the light-receiving element 1 can perform photoelectric conversion of a sufficient quantity of light to output electrical signals of high quality. Therefore, a reproduction signal and an error detection signal generated based on the electrical signals can be kept at initial quality without being deteriorated due to aging of the element.

The operation of the optical head 51 will now be described. Divergent laser light emitted by the laser diode 53 enters the polarization beam splitter 55. A linearly polarized component in a predetermined polarization direction is transmitted by the polarization beam splitter 55 and enters the quarter wave plate 57. A linearly polarized component orthogonal to the polarization direction is reflected and enters the power monitoring photodiode 61 at which the intensity of the laser light is measured.

The linearly polarized light which has entered the quarter wave plate 57 is transmitted by the quarter wave plate 57 and becomes circularly polarized light. The circularly polarized light is transformed by the collimator lens 59 into parallel light which is then transmitted by the collimator lens 59, converged by the objective lens 63, and enters a recording layer of the optical recording medium 65. Circularly polarized light reflected at the recording layer of the optical recording medium 65 is transformed by the objected lens 63 into parallel light which is then transmitted by the collimator lens 59 and enters the quarter wave plate 57. By being transmitted through the quarter wave plate 57, the circularly polarized light is transformed into linearly polarized light which is rotated at 90° in polarization direction from the initial linearly polarized light, and the linearly polarized light enters the polarization beam splitter 55. The linearly polarized light is reflected by the polarization beam splitter 55 and enters the sensor lens 67.

The light transmitted by the sensor lens 67 enters the cylindrical lens 71. The light which has entered the cylindrical lens 71 is converged on the light-receiving portion 11 of the light-receiving element 1. Since the deposition of dust on the light-receiving portion 11 of the light-receiving element 1 is prevented, any reduction in the quantity of received light can be prevented even if the element is kept in an operating environment for a long time. Electrical signals obtained through photoelectric conversion of the light received by the light-receiving element 1 are output to predetermined circuit provided in the optical recording/reproduction apparatus to generate a reproduction signal and an error detection signal.

The light-receiving element 31 according to the related art is mounted on an aluminum plate, and the element is mounted on a frame of the optical head in a sealed structure which is provided by using the aluminum plate as a cover member for sealing. In the optical head according to the related art, the deposition of dust in the air on the light-receiving element 31 is suppressed in such a manner. On the contrary, in the case of the light-receiving element 1 of the present embodiment, since the deposition of dust in the air can be prevented, there is no need for a sealed structure in mounting the element on an optical head. Since there is no need for a member for sealing the light-receiving element 1, the number of members used in an optical head can be reduced, and an optical head can be provided at a low cost. Further, since the light-receiving element 1 can be mounted on an optical head with a relatively high degree of freedom, flexibility in designing the shape of an optical head can be increased.

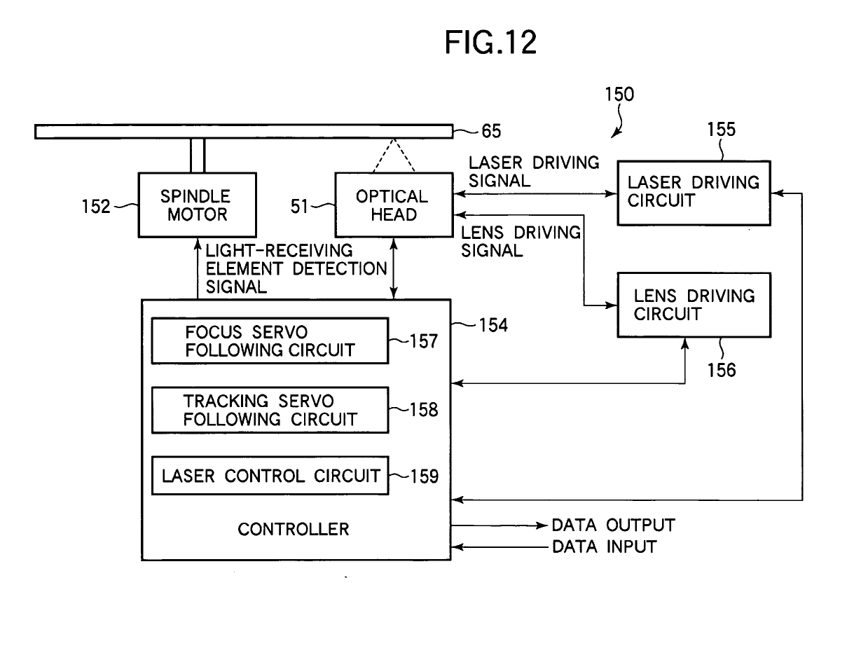

An optical recording/reproduction apparatus according to the present embodiment will now be described with reference to FIG. 12. The optical recording/reproduction apparatus includes an optical head for recording or reproducing information in or from predetermined regions of a plurality of tracks formed in the radial direction of an optical recording medium in the form of, for example, a disc, the track extending in the circumferential direction of the optical recording medium. Optical heads include record-only types which are used only for recording information in optical recording media, reproduction-only types which are used only for reproducing information, and recording/reproduction types which can be used for both of recording and reproduction. Therefore, apparatus incorporating those types of optical heads constitutes optical recording apparatus, optical reproduction apparatus, and optical recording/reproduction apparatus, respectively. Hereinafter, all types of apparatus will be generally referred to as optical recording/reproduction apparatus.

FIG. 12 shows a schematic configuration of an optical recording/reproduction apparatus 150 incorporating an optical head 51 according to the present embodiment. As shown in FIG. 12, the optical recording/reproduction apparatus 150 includes a spindle motor 152 for rotating an optical recording medium 65, an optical head 51 for irradiating the optical recording medium 65 with laser beam and receiving reflected light from the medium, a controller 154 for controlling operations of the spindle motor 152 and the optical head 51, a laser driving circuit 155 for supplying a laser driving signal to the optical head 51, and a lens driving circuit 156 for supplying a lens driving signal to the optical head 51. A light-receiving element 1 (not shown in FIG. 12) provided in the optical head 51 is disposed such that a substrate surface of a silicon substrate 9 formed with a light-receiving portion 11 (both of the components are not shown in FIG. 12) extends substantially in the vertical direction when the element is actually used.

The controller 154 includes a focus servo following circuit 157, a tracking servo following circuit 158, and a laser control circuit 159. When the focus servo following circuit 157 operates, an information-recording surface of the rotating optical recording medium 65 is focused. When the tracking servo 158 is activated, a spot of a laser beam automatically follows up an eccentric signal track on the optical recording medium 65. The focus servo following circuit 157 and the tracking servo following circuit 158 have an automatic gain control function for automatically adjusting a focus gain and a tracking gain, respectively. The laser control circuit 159 is a circuit for generating a laser driving signal to be supplied by the laser driving circuit 155, and the circuit generates an appropriate laser driving signal based on recording condition setting information recorded on the optical recording medium 65.

It is not essential that the focus servo following circuit 157, the tracking servo following circuit 158, and the laser control circuit 159 are circuits incorporated in the controller 154, and they may be components separate from the controller 154. Further, it is not essential that those circuits are physical circuits, and they may alternatively be programs executed in the controller 154.

The invention is not limited to the above-described embodiment and may be modified in various ways.

In the light-receiving element 1 of the above-described embodiment, the light-receiving portion 11 is exposed at the opening 4 formed in the light entrance region 2, but the invention is not limited to such a configuration. For example, the light-receiving portion may be covered by the cover layer and not to be exposed at the light entrance region. What is required for a light-receiving element is that it includes a cover layer formed with a thickness that is greater in a non-light entrance region around a light-receiving portion than in a light entrance region above the light-receiving portion when viewed in the normal direction of a substrate surface of a silicon substrate. Thus, the light-receiving element can provide the same effect as that of the light-receiving element 1 of the embodiment, although the light-receiving portion is not exposed.

Although the light-receiving element 1 of the above-described embodiment includes the non-light-entrance region 5 provided around the light entrance region 2, the invention is not limited to such a configuration. For example, what is required for a light-receiving element is that a non-light-entrance region 5 of the element is disposed at least above a light entrance region 2 in the vertical direction when a substrate surface of a silicon substrate is disposed in the vertical direction during practical use of the element. In this case, the light-receiving element can also provide the same effect as that of the above-described embodiment.

Although the light-receiving element 1 of the above-described embodiment employs the silicon substrate 9 as the substrate to form the light-receiving portion 11, the invention is not limited to such a configuration. For example, a light-receiving element may employ an SOI (Silicon on Insulator) substrate as a substrate to form a light-receiving portion. Then, the element can still provide the same effect as thus described.

Although the light-receiving elements 1 of the above-described embodiments shown in FIGS. 1A, 1B, 1C, 3, 4, and 5 have the outer surface 5a in the form of a curved surface in the neighborhood of the light entrance region 2, the invention is not limited to such a configuration. For example, the outer surface in the neighborhood of the light entrance region 2 may have a shape that is a combination of a plurality of flat surfaces surrounding the light entrance region. In this case again, the cover layer will have a thickness that is greater in the non-light-entrance region around the light-receiving portion than in the light entrance region above the light-receiving portion when viewed in the normal direction of the substrate surface of the silicon substrate. Therefore, a light-receiving element having such a cover layer can provide the same effect as that of the above-described embodiment.

What is claimed is:

1. A light-receiving element having a substrate surface of which is vertically disposed in practical use, comprising:
a light-receiving portion formed on the substrate; and
a cover layer which is disposed to cover the substrate and which is formed with a thickness that is greater in a non-light-entrance region around the light-receiving portion than in a light entrance region above the light-receiving portion when viewed in a normal direction of the substrate surface.

2. A light-receiving element according to claim 1, wherein an outer surface of the non-light-entrance region is inclined such that a height of the outer surface becomes smaller toward the light entrance region.

3. A light-receiving element according to claim 2, wherein the outer surface is inclined so as to constitute a curved surface in a neighborhood of the light entrance region.

4. A light-receiving element according to claim 2, wherein the outer surface is inclined in two stages such that the height of the outer surface becomes smaller toward the light entrance region.

5. A light-receiving element according to claim 1, wherein the non-light-entrance region has a substantially constant thickness.

6. A light-receiving element according to claim 2, wherein the outer surface is formed substantially perpendicularly to the substrate surface in a neighborhood of the light entrance region.

7. A light-receiving element according to claim 1, further comprising:
a circuit board on which the substrate is mounted, wherein the cover layer is formed across the substrate and the circuit board.

8. A light-receiving element according to claim 1, wherein the cover layer has an opening formed in the light entrance region to expose the light-receiving portion.

9. A light-receiving element according to claim 1, wherein the cover layer is made of a transparent material.

10. A light-receiving element according to claim 8, wherein the cover layer is made of an opaque material.

11. A light-receiving element according to claim 9, wherein the cover layer is made of a resin material.

12. A light-receiving element according to claim 11, wherein the resin material is epoxy resin or silicone resin.

13. A light-receiving element according to claim 1, wherein the substrate is a silicon substrate.

14. An optical head comprising:
an objective lens for converging light emitted by a light source on an optical recording medium; and
a light-receiving element having a substrate surface of which is disposed substantially vertically in practical use, the light-receiving element receiving light reflected at an optical recording medium, wherein the light-receiving element is a light-receiving element according to claim 1.

15. An optical recording/reproduction apparatus comprising an optical head according to claim 14.
